(19) United States
(12) Patent Application Publication
(10) Pub. No.: US 2012/0216060 A1
(43) Pub. Date: Aug. 23, 2012

(54) NOISE REDUCTION CIRCUIT, ELECTRONIC DEVICE, AND NOISE REDUCTION METHOD

(75) Inventors: Takayuki OCHIAI, Oume-shi (JP); Tetsunari ICHIMURA, Oume-shi (JP)

(73) Assignee: KABUSHIKI KAISHA TOSHIBA, Tokyo (JP)

(21) Appl. No.: 13/337,672

(22) Filed: Dec. 27, 2011

(30) Foreign Application Priority Data
Feb. 23, 2011 (JP) 2011-037592

(51) Int. Cl. G06F 1/00

(52) U.S. Cl. 713/323

(57) ABSTRACT

According to one exemplary embodiment, a noise reduction circuit includes: a controller which changes any one of a cycle of an active state and a time-period of each of the active state and an idle state to cause a CPU to intermittently operate.

### CROSS REFERENCE TO RELATED APPLICATION(S)

The application is based upon and claims the benefit of priority from Japanese Patent Application No. 2011-037592 filed on Feb. 23, 2011, the entire contents of which are incorporated herein by reference.

### FIELD

Exemplary embodiments described herein relate generally to a noise reduction circuit, an electronic device, and a noise reduction method, which take measures against the “whine” of capacitors while enabling an electric power-saving function.

### BACKGROUND

For example, in an easily-portable and battery-operable personal computer, there is one controller that switches the state of a central processing unit (CPU) alternately between an active state and an idle state thereby causing the CPU to intermittently operate as one power-saving measure.

However, according to any of related arts for controlling such a type of the intermittent operation of the CPU, a set of the active state and the idle state of the CPU is repeated at a constant cycle. Accordingly, the related arts have the whine of capacitors.

The following types of countermeasures against the whine of capacitors have been considered.

(1) Low-dielectric-constant capacitors/capacitors provided with metal terminals are used.

(2) The use of the power-saving function is inhibited.

(3) Many capacitors are mounted to prevent voltage variation.

However, the countermeasure (1) is costly, because of the high unit prices of the components. The countermeasure (2) sometimes causes fatal problems in portable devices, because the power-saving function is inactive. The countermeasure (3) has problems in that when large variation in electric-current occurs, high-capacity capacitors such as electrolytic capacitors are needed, and that a large area and a high height are frequently needed to mount such capacitors.

There have been demands for techniques capable of implementing power-saving by methods more flexible than these examples. No means for realizing such demands has been known.

### BRIEF DESCRIPTION OF THE DRAWINGS

Exemplary embodiments of the present invention will be described in detail based on the following figures, wherein:

FIG. 1 is a block diagram showing a configuration of a personal computer according to an embodiment;

FIG. 2 is a block diagram showing a functional configuration of a primary part of the personal computer according to the embodiment;

FIG. 3 is an explanatory diagram showing an operation of a power-saving synchronization signal indicating the entry and the exit into and from a power-saving function-mode according to the embodiment;

FIG. 4 is a diagram showing an example of a circuit for detecting that the entry and the exit into and from a power-saving function-mode according to the embodiment is performed at a certain cycle;

FIG. 5 is a diagram showing an example of a circuit for changing the certain cycle when the entry and the exit into and from a power-saving function-mode according to the embodiment are performed at a certain cycle;

FIG. 6 is an explanatory diagram showing detection patterns obtained by the circuit shown in FIG. 4 according to the embodiment;

FIG. 7 is a timing chart showing an example of a sequence of operations relating to FIGS. 4 and 5 according to the embodiment; and

FIG. 8 is a flowchart showing a firmware control process used in another embodiment of this invention.

### DETAILED DESCRIPTION OF THE EXEMPLARY EMBODIMENTS

In general, according to one exemplary embodiment, a noise reduction circuit includes: a controller which changes any one of a cycle of an active state and a time-period of each of the active state and an idle state to cause a CPU to intermittently operate.

Hereinafter, embodiments of the invention are described with reference to the accompanying-drawings.

### First Embodiment

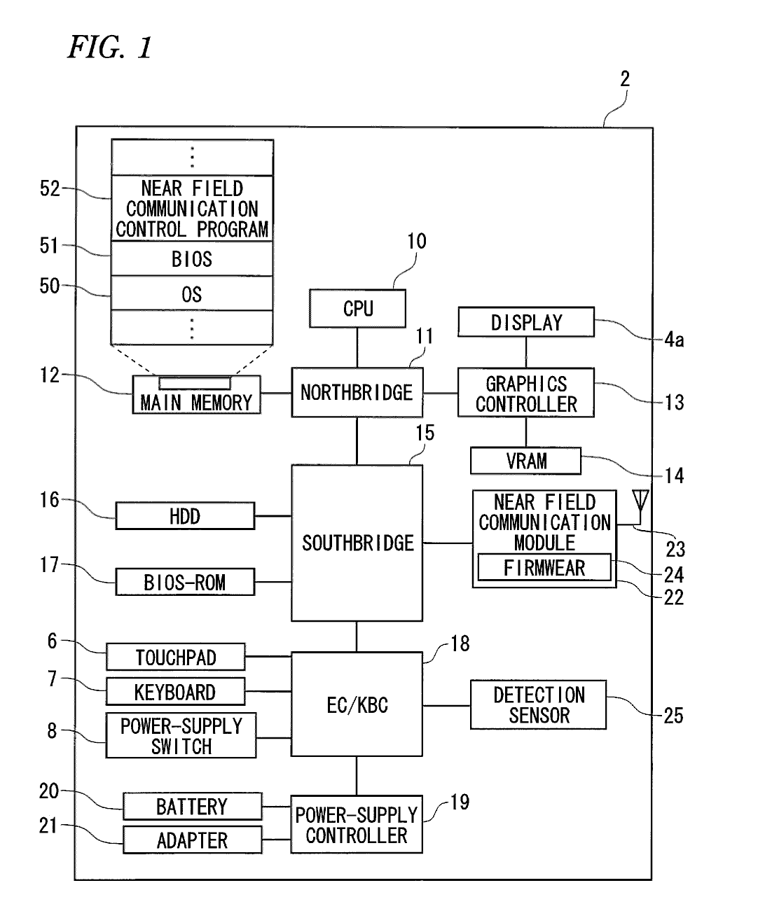

A first embodiment of the invention is described with reference to FIGS. 1 to 7.

Referring first to FIG. 1, the function of a personal computer 2 serving as an electronic device is described hereinafter.

The personal computer 2 is configured to include a display 4a, a touchpad 6, a keyboard 7, a power-supply switch 8, a CPU 10, a northbridge 11, a main memory 12, a graphics controller 13, a video random access memory (VRAM) 14, a southbridge 15, a hard disk drive (HDD) 16, a BIOS-read-only memory (ROM) 17, an embedded controller/keyboard controller (EC/KBC) 18, a power supply controller 19, a battery 20, an alternate current (AC) adapter 21, a near field communication module 22, and a detection sensor 25. The near field communication module 22 includes a near field communication antenna 23, and a near field communication firmware 24.

The CPU 10 is a processor provided to control an operation of the personal computer 2. The CPU 10 executes an operating system (OS) 50 and various application programs loaded into the main memory 12 from the HDD 16. In addition, after a system BIOS 51 stored in the BIOS-ROM 17 is loaded into the main memory 12, the CPU 10 executes the system BIOS 51. The system BIOS 51 is a program for hardware control. The CPU 10 executes a near field communication program 52 and controls near field communication performed by the near field communication module 22.

The northbridge 11 is a bridge device connecting between a local bus of the CPU 10 and the southbridge 15. The northbridge 11 incorporates a memory controller for controlling access to the main memory 12. In addition, the northbridge 11 has the function of executing communication with the graphics controller 13 via an accelerated graphics port (AGP) bus or the like.

The main memory 12 is what is called a working memory into which the OS 50 and the various application programs stored in the HDD 16, and the system BIOS 51 stored in the BIOS-ROM 17 are loaded.

The graphics controller 13 is a display controller for controlling a display 4a to be used as a display monitor of the computer 2. The graphics controller 13 generates, from display data written to the VRAM 14 by the operating system/the application program, image signals representing a display image to be displayed in the display 4a.

The southbridge (or a platform controller hub (PCH)) 15 accesses the BIOS-ROM 17 and controls disk drives (I/O devices) such as the HDD 16 and an optical disk drive (ODD). In the southbridge 15, a real time clock (RTC (not shown)) and functions components (not shown) relating to a universal serial bus (USB) and a serial advanced technology attachment (SATA).

The HDD 16 is a storage unit for storing the OS 50, the various application programs, and the like. The HDD 16 stores, e.g., image data received by near field communication performed by the near field communication module 22.

The BIOS-ROM 17 is a nonvolatile and rewritable memory which stores the system BIOS 51 that is a program for hardware control.

The EC/KBC 18 controls the keyboard 7 and the touchpad 6 that are provided as input devices. The EC/KBC 18 is a one-chip microcomputer that monitors and controls various devices (peripheral devices, sensors, power-supply circuits, and the like), regardless of the system status of the personal computer 2. In addition, the EC/KBC 18 has the function of performing the power-on/power-off of the personal computer 2 in response to a user's operation performed on the power-supply switch 8 in cooperation with the power-supply controller 19.

If external electric-power is supplied via the AC adapter 21, the power-supply controller 19 generates system power to be supplied to each component (e.g., a computer main unit 3, and a display unit 4) of the personal computer 2 using the external electric-power supplied from the AC adapter 21. If the external power is not supplied via the AC adapter 21, the power-supply controller 19 generates system power to be supplied to each component of the personal computer 2, using the battery 20.

The near field communication module 22 exchanges data to and from an external device through radio signals using an induction electric-field. When the external device approaches the near field communication module 22 within a communicatable distance (e.g., about 3 centimeters (cm)) therefrom, the near field communication antenna 23 is connected to a near field communication antenna of the external device with the induction electric-field. Thus, wireless communication can be executed. The near field communication module 22 converts, into digital signals, radio signals transmitted and received by the near field communication antennal 23. Then, the near field communication module 22 transmits the digital signals into the inside of the computer 2.

The near field communication firmware 24 adds read/write function control information or the like to a free space of a request message/response message used to establish protocol conversion layer (PCL) communication.

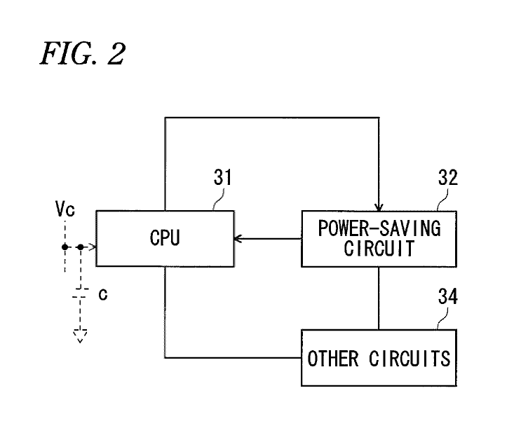

FIG. 2 is a block diagram showing a functional configuration of a primary part of the personal computer 2 according to the embodiment.

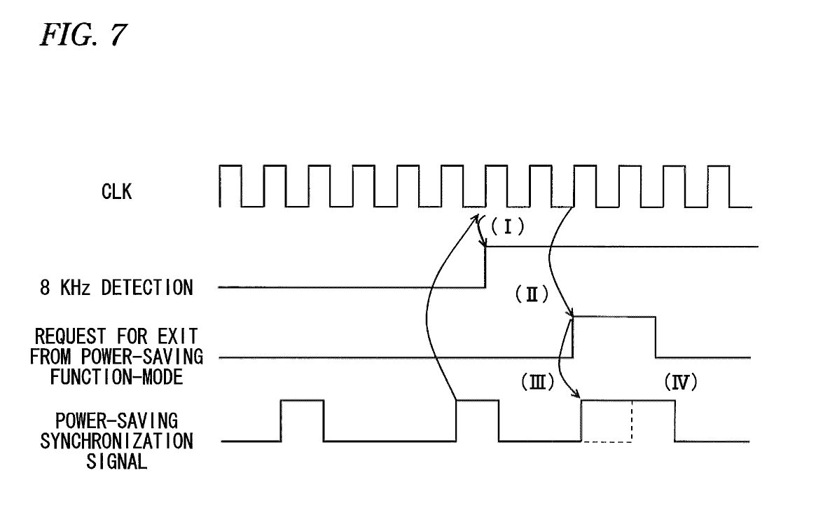

In FIG. 2, reference numeral 31 designates a CPU which controls the entire system and corresponds to the CPU 10. In this embodiment, the CPU 31 repeatedly takes an active state and an idle state, under the control of a power-saving circuit 32 which will be described below, to be inhibited from continuously and intermittently operating at the same cycle during a power-saving operation, and to operate and execute processing while controlled, as described below with reference to FIG. 7, to intermittently operate. Incidentally, reference character “Vc” denotes a power supply for an operation of the CPU 31, and reference character “c” designates a bypass ceramic capacitor serving as a vibration suppression target provided in a power supply circuit for the CPU 31.

Reference numeral 32 designates a power-saving circuit for controlling the above CPU 31 so that the CPU 31 intermittently operates during a power-saving operation and repeatedly takes the active state and the idle state so as not to intermittently and continuously operate at the same cycle. For example, the power-saving circuit 32 controls the CPU 31 to intermittently operate, as illustrated in FIG. 7.

Reference numeral 34 denotes other circuits including a peripheral circuit of the CPU 31. In this embodiment, most of the circuits 34 do not relate directly to the invention. Therefore, the description of the circuits 34 is omitted.

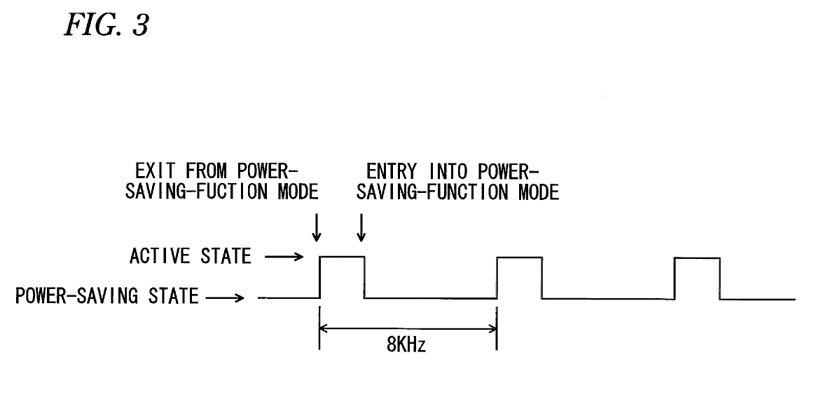

FIG. 3 is an explanatory diagram showing an operation of a power-saving synchronization signal indicating the entry and the exit into and from a power-saving function-mode according to the embodiment. Hereinafter, it is described a case that the whine of capacitors occurs and noise is generated if the entry time and the exit time into and from a power-saving function-mode is 31.25 microseconds (us) or more, and if the entry period and the exit period into and from the power-saving function-mode is 8 KHz.

For example, a USB driver causes the above cycle according to USB polling cycle specifications. In addition, if a certain cycle occurs, which relates to the above near field communication module 22 and affects the CPU 31, an electronic apparatus can be configured to be compatible with the certain cycle and to be equivalent to that configured to include the following circuits and operate according to the following flows.

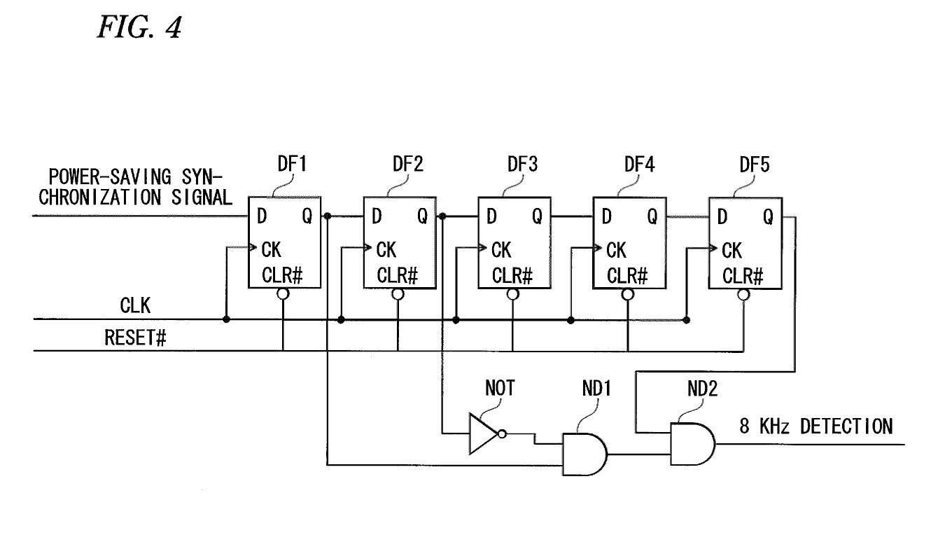

FIG. 4 shows an example of a circuit for detecting that a set of the entry of the CPU 31 into the power-saving function-mode and the exit of the CPU 31 therefrom is performed at a certain cycle (in this example, 8 KHz). Five D-type flip-flops DF1 to DF5 are cascade-connected as basic components of this circuit. Power-saving synchronization signals, and signals RESET # are output from the CPU 31 and input to this circuit. Clock signals CLK are generated by a real-time clock (RTC).

In addition, an output signal of the flip-flop DF2 is inverted by a NOT-gate. The output signal of DF1 and an output of an NOT-gate are AND-ed by AND-gate ND1. Then, an output signal of the AND-gate ND1 and that of the flip-flop DF5 are AND-ed by an AND-gate ND2. An output signal of the AND-gate ND2 is an 8 KHz-detection signal.

An equivalent apparatus can be configured using shift registers, instead of the flip-flops.

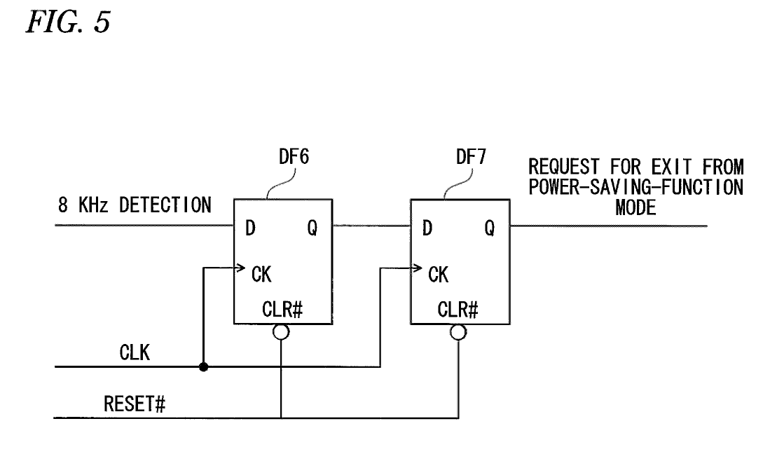

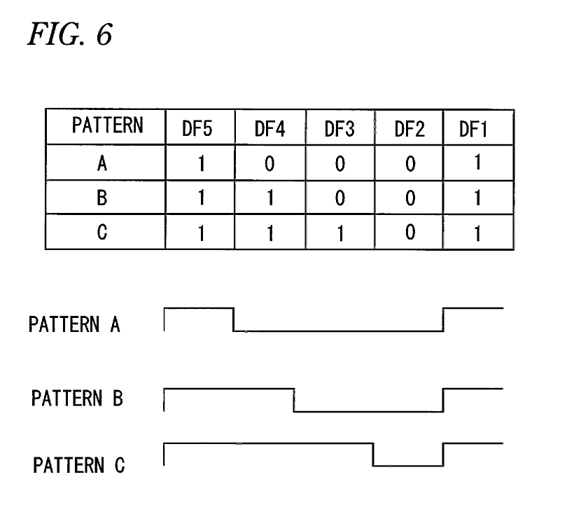

FIG. 5 shows an example of a circuit for changing a certain cycle when a set of the entry of the CPU 31 into the power-saving function-mode and the exit of the CPU 31 therefrom is performed at the certain cycle. This example of the circuit generates an exit-from-power-saving-function-mode request signal from an 8 KHz-detection signal by controlling two stages of D-type flip-flops DF6 and DF7 with clock signals. FIG. 6 is an explanatory diagram showing detection patterns obtained by the circuit shown in FIG. 4. FIG. 7 is a timing chart showing an example of a sequence of operations relating to FIGS. 4 and 5.

The frequency of the clock signal CLK shown in FIG. 4 is assumed to be 32 KHz (a sampling interval=31.25 us). FIG. 6 shows patterns of 1 cycle in the case that a set of the entry of the CPU 31 into the power-saving function-mode and the exit of the CPU 31 therefrom is repeated at a cycle of 8 KHz. The number of the patterns is increased or decreased with increase or decrease of the number of the stages of the flip-flops, which is five that is the number of the stages of the cascade-connected D-type flip-flops DF1 to DF5 shown in FIG. 4. When the power-saving synchronization signal is changed according to the patterns shown in FIG. 6 (corresponding to the frequency of the cycle (=8 KHz)), an 8 KHz-detection signal is asserted (at moment (I) shown in FIG. 7). Then, after the lapse of two clock-periods, an exit-from-power-saving-function-mode request signal is asserted in the circuit shown in FIG. 5 at moment (II) shown in FIG. 7.

In response to the exit-from-power-saving-function-mode request signal, the CPU 31 exits from the power-saving function-mode. Thus, as indicated at moment (III) in FIG. 7, the CPU 31 comes to nonperiodically enter or exit the power-saving function-mode. When the CPU 31 succeeds in exit from the power-saving function-mode, the signal RESET# is asserted. Then, the circuit returns to the detection of the patterns shown in FIG. 6 (corresponding to the frequency of the cycle (=8 KHz)).

The BIOS 51 or the CPU 31 can deal with the exit-from-power-saving-function-mode request signal by connecting this signal to, e.g., a signal according to which a system management interrupt (SMI) can be generated from the PCH. In a configuration in which a plurality of devices deal with the cycle of the entry and the exit thereof, it is advisable that the request signal relating to the plurality of devices is wired thereto.

The falling edge of the power-saving synchronization signal shown in FIG. 7 can be set such that the entry of the CPU 31 into the power-saving function-mode is performed subsequently to the detection of reduction in load imposed on the CPU 31 due to the reception of, e.g., a no-operation (NOP) instruction from the BIOS 51 after the CPU 31 activated by the SMI causes the BIOS 51 to operate.

Even in the case of suppressing unnecessary radiation (EMI) due to the power-saving function, the present countermeasure is sometimes effective.

### Second Embodiment

A second embodiment of the invention is described hereinafter with reference to FIGS. 1 to 4 and 8. The description of components common to the first embodiment is omitted.

Instead of the circuit for generating a synchronized detection signal as shown in FIG. 5, an apparatus capable of treating with asynchronous signals can be implemented by a firmware or the like. In this case, this apparatus can deal with not only a cycle of 8 KHz but another cycle. For example, such an apparatus can be implemented by providing, in or out of the detection sensor 25, a device equivalent to the circuit shown in FIG. 4 and using a firmware (not shown) 24 provided in the detection sensor 25.

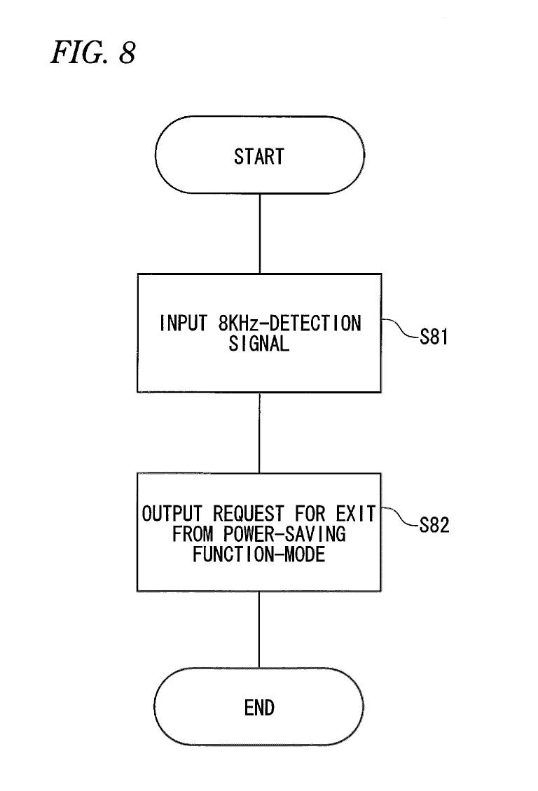

A flowchart of a process of controlling this firmware is illustrated in, e.g., FIG. 8. In step S81, an 8 KHz-detection signal is input to the circuit. In step S82, a request for the exit of the CPU from the power-saving function-mode is output (e.g., the monitoring and controlling of various devices (peripheral devices, a sensor, and a power-supply circuit, and the like) by, e.g., the EC/KBC 18 can be utilized).

The first and second embodiments have the following two functions as features. Thus, these embodiments take countermeasures against the whine of capacitors.

(1) The function of detecting that a set of the entry and the exit of the CPU into and from the power-saving function-mode is performed at a certain cycle.

(2) The function of changing the cycle when a set of the entry and the exit of the CPU into and from the power-saving function-mode is performed at the certain cycle.

The present embodiments are adapted to detect the cycle of performing the power-saving function and changing the cycle. As compared with related arts, the present embodiments have the following advantages and features.

(1) The countermeasure can be performed at low cost.

(2) The countermeasure can be taken such that the power-saving function is prevented as much as possible from being hindered.

(3) The countermeasure can be taken even if the power-saving circuit doesn't have the function of changing the cycle.

When the set of the entry and the exit of the CPU into and from the power-saving function-mode is continuously performed, the whine of the capacitors is sometimes generated and problematic as noise. Accordingly, the countermeasures are taken by detecting that the power-saving function is performed at a cycle set in a zone of audibility, and imparting to the apparatus the function of changing the cycle.

As compared with the related arts, according to the present embodiments, since the cycle of repeating the set of the entry and the exit of the CPU into and from the power-saving function-mode is detected by hardware, the present embodiments can be applied to the set of the entry and the exit of the CPU into and from the power-saving function-mode at a certain cycle by software. Further, the present embodiments can solve the problems while the power-saving function is performed as much as possible.

While certain exemplary embodiment has been described, the exemplary embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A noise reduction circuit comprising:
a controller configured to change
a cycle of an active state or
a time-period of the active state and an idle state to cause a CPU to intermittently operate.

2. The circuit of claim 1, wherein the controller comprises three or more stages of cascaded flip-flops.

3. The circuit of claim 1, wherein the controller comprises a shift register.

4. An electronic device comprising:
a CPU; and
a controller configured to change
a cycle of an active state or
a period of the active state and an idle state to cause a CPU to intermittently operate.

5. A noise reduction method suitable for use in an electronic device comprising a power-saving controller that causes a CPU to intermittently operate, the method comprising:
changing a cycle and a time-period of an active state of the CPU while the CPU operates intermittently; and
inhibiting the CPU from continuously performing intermittent operation at the same cycle during a power-saving control operation.
